(19) United States
(12) Patent Application Publication
(10) Pub. No.: US 2009/0282110 A1
(43) Pub. Date: Nov. 12, 2009

(54) CUSTOMIZABLE DYNAMIC E-MAIL DISTRIBUTION LISTS

(75) Inventors: Dana Price, Cary, NC (US); Thomas Bitonti, Cary, NC (US); Wendell Bouknight, Clayton, NC (US); Thomas Haynes, Apex, NC (US)

Correspondence Address: Novak Druce + Quigg LLP, CityPlace Tower, 525 Okeechobee Blvd., Fifteenth-Floor, WEST PALM BEACH, FL, 33401, US

(73) Assignee: INTERNATIONAL BUSINESS MACHINES CORPORATION, Armonk, NY (US)

(21) Appl. No.: 12/119,165

(22) Filed: May 12, 2008

(51) Int. Cl. G06F 15/16

(52) U.S. Cl. 709/206

(57) ABSTRACT

A computer-implemented method for generating a customized dynamic distribution e-mail list is provided. The method includes determining a predefined addressee-selecting rule in response to a user-executed command to send an e-mail. The method also includes selecting at least one addressee from an electronic data file based upon the addressee-selecting rule. The method further includes, for each addressee selected, inserting a corresponding address into a predetermined field of an e-mail prior to conveying the e-mail over a data communications network.

### FIELD OF THE INVENTION

The present invention is related to the field of data communications networks, and more particularly, to techniques for exchanging data over a data communications network.

### BACKGROUND OF THE INVENTION

Electronic mail (e-mail) is an asynchronous communication medium that allows users to exchange messages, with or without attachments, over a data communications network, such as the Internet. E-mail thus provides an efficient mechanism for the rapid, convenient, and inexpensive exchange of messages and other data.

An important aspect of e-mail, in contrast to ordinary postal mail, is that with e-mail a user can send many copies of a message to multiple recipients at a time. Nevertheless, sending an e-mail message to members of a group remains a challenge when the group membership changes frequently.

A list of members can be maintained on a list server at a central location so that sending an e-mail to the server will ensure that the e-mail is sent to designated group members. This conventional approach, however, requires that a list be maintained, notwithstanding the fact that it will often be the case that user-specified groups on the list are not going to be included. Directories, such as the Lightweight Directory Access Protocol (LDAP), impose the same types of limitations when there is a need for a list to be maintained at an external location. Examples of lists that would not be handled effectively and efficiently by conventional mechanisms include, work department members, social networking groups, contributors to a particular blog, and individuals who have indicated an interest in a particular webpage, for example.

### SUMMARY OF THE INVENTION

The present invention is directed to a system, methods, and computer product for creating customized, dynamic e-mail distribution lists. With certain embodiments of the invention, an e-mail list is created at the moment in time that the list is being used in sending an e-mail over a data communications network. Rules for creating e-mail lists, according to an embodiment of the invention, can vary with respect to different lists, according to user-supplied specifications.

One embodiment of the invention is a system for generating a customized dynamic distribution e-mail list. The system can include one or more processors. The system also can include a network interface for communicatively linking the one or more processors to a data communications network. Additionally, the system can include an addressee-selecting module that executes on the one or more processors. The module, more particularly, can be configured to respond to a user-executed command to send an e-mail over the data communications network by determining a predefined addressee-selecting rule. Based upon the addressee-selecting rule, the module can select at least one addressee from one or more electronic data files. For each addressee selected, the module can insert a corresponding address into a predetermined field of an e-mail prior to conveying the e-mail over a data communications network.

Another embodiment is a computer-implemented method for generating a customized dynamic distribution e-mail list. The method can include responding to a user-executed command to send an e-mail by determining a predefined addressee-selecting rule. The method also can include selecting at least one addressee from an electronic data file based upon the addressee-selecting rule. The method further can include, for each addressee selected, inserting a corresponding address into a predetermined field of an e-mail prior to conveying the e-mail over a data communications network.

Yet another embodiment of the invention is a computer-readable medium in which is embedded computer-readable code that when loaded on a computer causes the computer to perform the following procedure: determine a predefined addressee-selecting rule in response to a user-executed command to send an e-mail; based upon the addressee-selecting rule, select at least one addressee from an electronic data file; and, for each addressee selected, insert a corresponding address into a predetermined field of an e-mail prior to conveying the e-mail over a data communications network.

### BRIEF DESCRIPTION OF THE DRAWINGS

There are shown in the drawings, embodiments which are presently preferred. It is expressly noted, however, that the invention is not limited to the precise arrangements and instrumentalities shown in the drawings.

FIG. 1 is a schematic view of an exemplary environment in which a system, according to one embodiment of the invention, can be utilized.

FIG. 2 is a schematic view of a system for generating a customized dynamic distribution e-mail list, according to one embodiment of the invention.

FIG. 3 is a flowchart of exemplary steps in a method for generating a customized dynamic distribution e-mail list, according to another embodiment of the invention.

FIG. 4 is a flowchart of exemplary steps in a method for generating a customized dynamic distribution e-mail list, according to yet another embodiment of the invention.

FIG. 5 is a flowchart of exemplary steps in a method for generating a customized dynamic distribution e-mail list, according to still another embodiment of the invention.

FIG. 6 is a flowchart of exemplary steps in a method for generating a customized dynamic distribution e-mail list, according to another embodiment of the invention.

FIG. 7 is a flowchart of exemplary steps in a method for generating a customized dynamic distribution e-mail list, according to yet another embodiment of the invention.

FIG. 8 is a flowchart of exemplary steps in a method for generating a customized dynamic distribution e-mail list, according to still another embodiment of the invention.

### DETAILED DESCRIPTION

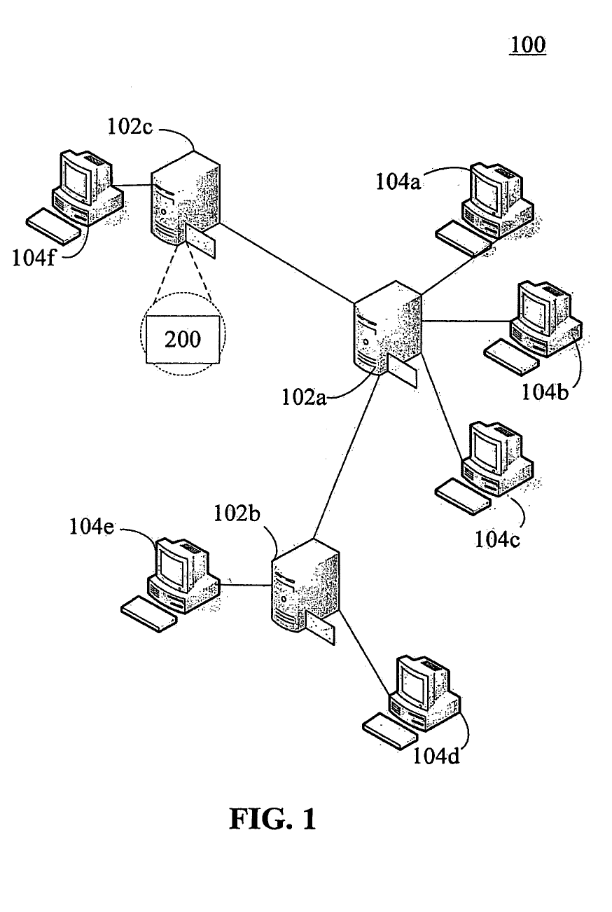

FIG. 1 is a schematic view of an exemplary environment 100 in which a system 200, according to one embodiment of the invention, can be utilized. The environment 100 is typical of an e-mail infrastructure and illustratively includes a plurality of mail servers 102a-c. Although shown as being communicatively linked to one another, the mail servers 102a-c can alternately be communicatively linked through a more elaborate data communications network, such as the Internet, comprising one or more intermediate nodes. Illustratively, the environment 100 further includes a plurality of user agents 104a-f, each of which is communicatively linked to one of the plurality of mail servers 102a-c.

The user agents 104a-f can be any computing device that has the capability to communicatively link, whether wirelessly or through a wired connection, directly or through a network to other agents and to exchange e-mails. The user agents 104a-f can execute an application-layer program that, based upon a protocol such as Simple Mail Transfer Protocol (SMTP), permits users to read, reply to, forward, compose, and save, e-mails.

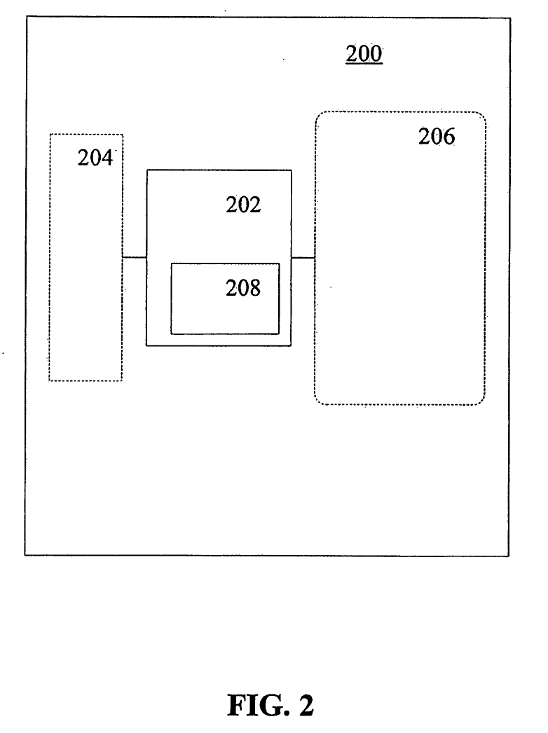

Referring additionally to FIG. 2, a more detailed schematic view of the system 200 for generating a customized dynamic distribution e-mail list, according to one embodiment, is provided. The system 200 illustratively includes one or more processors 202, which can be implemented in an arrangement of registers, logic gates, and other logic-based processing circuitry (not explicitly shown). The system 200 can optionally include a network interface 204 for connecting to a data communications network over which e-mails can be sent and received. The system 200 also can optionally include one or more electronic memory elements 206, communicatively linked to the one or processors 202, for storing electronic data and processor-executable code for electronically processing data.

In a particular embodiment, the one or more processors 202 and/or network interface 204 of the system 200 can be provided by a mail server 102c on which the system 200 operates. In alternative embodiments, however, the one or more processors 202 and and/or network interface 204 can comprise a stand-alone device or can be part of an independent computing device (not shown) that communicatively links to a mail server.

Certain operative features of the system 200 are provided by an addressee-selecting module 208. Preferably, the addressee-selecting module 208 is implemented in processor-executable code configured to execute on the one or more processors 202. In alternative embodiments, however, the addressee-selecting module 208 can be implemented in dedicated hardwired circuitry. In still other embodiments, the addressee-selecting module 208 can be implemented in a combination of processor-executable code and hardwired circuitry.

Operatively, the addressee-selecting module 208 is configured to respond to a user-executed command to send an e-mail over a data communications network. In response to the user-executed command, the addressee-selecting module 208 determines a predefined addressee-selecting rule. Based upon the addressee-selecting rule, the addressee-selecting module 208 selects one or more addressees from an electronic data file, the data file being stored in memory locally or remotely from the system 200. The addressee-selecting module 208, for each addressee selected, then inserts a corresponding address into a predetermined field of an e-mail prior to conveying the e-mail over a data communications network.

The following exemplary procedure, represented in pseudocode, illustrates an embodiment of the address-selecting module 208 implemented in processor-executable code:

```
class Sample_DynamicList {
  AddressList generateAddressList (AddressListEngine
  addressListEngine,
        AddressListGeneratorOptions addressListGeneratorOptions,
        AddressListGeneratorRule addressListGeneratorRule,
        AddressListGeneratorBindings addressListGeneratorBindings)
    throws AddressListException
  {
    AddressList addressList =
    AddressListFactory.INSTANCE.createAddressList( );
    addressListEngine.populateAddressList(addressList,
            addressListGeneratorOptions,
            addressListGeneratorRule,
            addressListGeneratorBindings);
    return addressList;
  }
}
```

The addressee-selecting module 208 can be configured to identify the electronic data file from among a plurality of different data files, the identification being based upon the addressee-selecting rule. In response thereto, the addressee-selecting module 208 can access the electronic data file. For example, for a list name titled “ABC Department Members” a corresponding rule of address creation can direct the device on which the system 200 operates to perform certain operations. Specifically, the rule can dictate that the following procedure be performed: go to company directory web page; log in; open page for department ABC manager; follow link to “People Managed;” and generate list of e-mail addresses from the collection of e-mail addresses in that division of the html source. In another example, the rule can correspond to a list name titled “All administrators at my child's school.” The corresponding rule can dictate the following procedure: go to the school website, access “Staff,” and collect e-mail addresses.

In another embodiment, the addressee-selecting module 208 can be configured to access the electronic data file at a remotely-located site and automatically perform a log-in procedure to access the electronic data file based upon the addressee-selecting rule. For example, a rule corresponding to a list name titled “My Soccer Pals,” can instantiate a-procedure according to which the user is initially directed to a soccer team's group Website, such as yahoogroup™, to collect addresses of team members and then to a social-planning Website for creating, sending, and/or managing online invitations, such as Evite.com™. A complete procedure dictated by the rule can be illustratively described as follows: go to yahoogroup for soccer team and collect addresses; go to Evite.com; log in; open soccer invitation and collect addresses; go to soccer club website and collect addresses. In another example, for a list name titled “People to Invite to Christmas Party,” a rule can dictate that the following procedure be performed go to Evite.com; log in; open invitation for a Christmas party; collect a list of e-mail addresses from those e-mails having responses of “Yes” and “Maybe.”

The above-described pseudocode can be adapted as illustrated in the following code sections for implementing the addressee-selecting module 208 so as to perform address selection in the context of Evite.com™. Following is the initial code-section:

```
class Sample_EviteList {
  AddressList generateAddressList(
      EvitePartyEngine evitePartyEngine,
      EvitePartyOptions evitePartyOptions,
      EvitePartyRule evitePartyRule,
      EviteBindings eviteBindings)
    throws AddressListException
  {
    AddressList addressList =
    AddressListFactory.INSTANCE.createAddressList( );
    evitePartyEngine.populateAddressList(
        addressList, evitePartyOptions, evitePartyRule, eviteBindings);
    return addressList;
  }
}
```

The data types corresponding to this address selection rule firstly include:

interface EviteMember {
Address getAddress( );
}

Continuing in the context of an Evite-related address-selecting rule, the following pseudocode generates an Evite party invitation and invitation response

```
interface EviteParty {
  EviteMember getHost( );
  List<EviteMember> getInvitees( );
  List<EvitePartyInvitation> getInvitations( );
}
interface EvitePartyInvitation {
  EviteParty getParty( );
  EviteMember getRecipient( );
  EvitePartyInvitationResponse getResponse( );
}
public enum EvitePartyInvitationResponse {
  NO, MAYBE, YES;
}
```

The following pseudocode exemplifies the implementation of the basic rule for selecting a party invitation for further processing, according to one embodiment:

```
class EvitePartyRule implements AddressListGeneratorRule {
  boolean select(EvitePartyInvitation invitation) {
    return ( (invitation.getResponse( )==
    EvitePartyInvitationResponse.YES ) ||
      (invitation.getResponse( ) ==
      EvitePartyInvitationResponse.MAYBE ) );
  }
}
```

Subsequently, options used to drive address list selection can be implemented, as exemplified in the following pseudocode. The parameters are illustratively credentials for an Evite member and the name of a party (of that member) that is to be processed.

```
interface EvitePartyOptions extends AddressListGeneratorOptions {
  EviteMemberCredentials getEviteMemberCredentials( );
  String getPartyName( );
}
```

Finally, after these preparatory code sections have executed, the actual engine code implemented in the following pseudocode executes for effecting address selection according to the defined rule:

```
class EvitePartyEngine implements AddressListEngine {
  void populateAddressList(AddressList addressList,
        EvitePartyOptions evitePartyOptions,
        EvitePartyRule evitePartyRule,
        EviteBindings eviteBindings)
    throws AddressListException
  {
    EviteMemberCredentials eviteMemberCredentials =
      evitePartyOptions.getEviteMemberCredentials( );
    EviteSession eviteSession;
    try {
      eviteSession = eviteBindings.login(eviteMemberCredentials);
    } catch ( EviteException e ) {
      throw new AddressListException(“Login failure”, e);
    }
    String partyName = evitePartyOptions.getPartyName( );
    EviteParty party;
    try {
      party = eviteSession.getEviteParty(partyName);
    } catch ( EviteException e ) {
      throw new AddressListException(
      “Failed to retrieve party [ “ + partyName + ” ]”, e);
    }
    for ( EvitePartyInvitation evitePartyInvitation :
    party.getInvitations( ) ) {
      if ( evitePartyRule.select(evitePartyInvitation) ) {
        addressList.addAddress(
          evitePartyInvitation.getRecipient( ).getAddress( ) );
      }
    }
  }
}
```

In this pseudo-code, the step “party=eviteSession.getEviteParty(partyName);” shows one location where, in a full implementation, the implementation can provide significant details for retrieving and scanning required data.

In this pseudo-code, the steps “for (EvitePartyInvitation evitePartyInvitation: party.getInvitations( ))” and “if (evitePartyRule.select(evitePartyInvitation))” together show one very simple rule for selecting party invitations. In this case, the selection of potential invitations and selection of actual invitations for the address list is provided in separate locations. In other cases, the selection of addresses can interleave calls to retrieve data objects (such as the EviteParty, EviteMember, and EvitePartyInvitation data objects) with applications of a selection rule. That would be the case, for example, when the retrieval of data objects requires the retrieval of potentially many linked data objects, and the scans for these data objects requires an application of the selection rule before proceeding with the retrieval of particular data objects. Also, the application of the selection rule during the retrieval of data objects might be necessary to limit the amount or depth of the scans for data objects.

In still another embodiment, the addressee-selecting module 208 can be configured to access the electronic data file at a remotely-located site and automatically link to another site, based upon the addressee-selecting rule. For example, a rule corresponding to a list name titled “Contributors to the XYZ Blog” can dictate the following procedure: go to the XYZ blog home page; collect e-mail addresses from that page; follow the “Next” link and collect addresses. The rule can further dictate that the procedure be repeated until there are no more “Next” links remaining. Thus, according to yet another embodiment, the addressee-selecting module 208 can be further configured to automatically determine when no additional links are identifiable and to successively link to a plurality of other sites until no additional links are identifiable.

Alternatively or additionally, the rule can specify that addresses are to be collected only from submissions that have been received within the last six months. According to still another embodiment, therefore, the addressee-selecting module 208 can be configured to select the at least one addressee from an electronic data file based upon a user-specified date and/or a user-specified time associated with the at least one addressee provided in the addressee-selecting rule.

The addressee-selecting module 208 can be further configured to select, based upon the addressee-selecting rule, one of a plurality of electronically stored messages pre-specified by a user. Once the appropriate message has been selected, the module 208 can cause the message to be inserted into a field of the e-mail prior to conveying the e-mail over a data communications network.

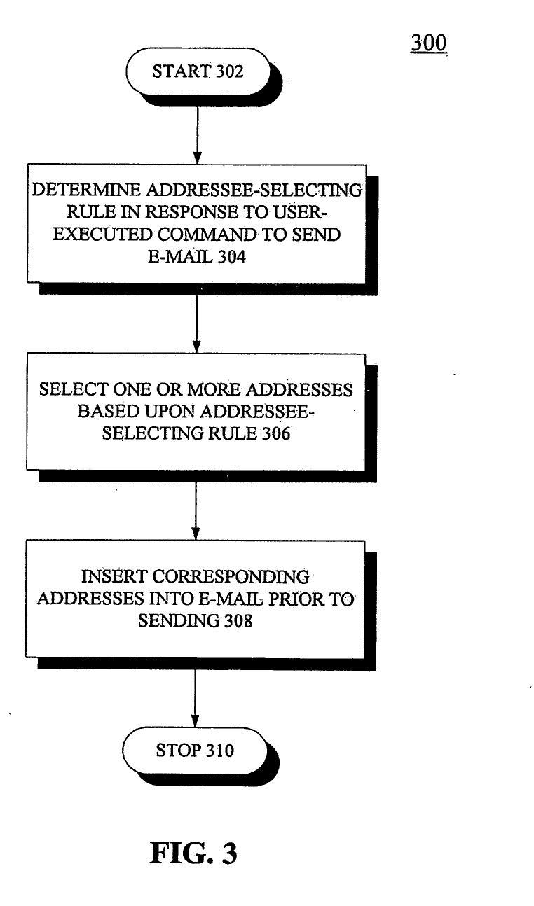

Referring now to FIG. 3, certain method aspects of the invention are illustrated. FIG. 3 is a flowchart of exemplary steps in a method 300 for generating a customized dynamic distribution e-mail list, according another embodiment of the invention. The method 300 illustratively includes, after the start at step 302, determining a predefined addressee-selecting rule in response to a user-executed command to send an e-mail at step 304. The method 300 also illustratively includes selecting at least one addressee from an electronic data file based upon the addressee-selecting rule at step 306. The method 300 further illustratively includes, for each addressee selected, inserting a corresponding address into a predetermined field of an e-mail prior to conveying the e-mail over a data communications network at step 308. The method 300 illustratively concludes at step 310.

According to one embodiment of the method 300, the selecting step can comprise identifying the electronic data file from among a plurality of different data files based upon the addressee-selecting rule, and, in response thereto, accessing the electronic data file. According to another embodiment of the method 300, the selecting step can comprise accessing the electronic data file at a remotely-located site and automatically performing a log-in procedure to access the electronic data file based upon the addressee-selecting rule.

In still another embodiment of the method 300, the selecting step comprises accessing the electronic data file at a remotely-located site and automatically linking to another site based upon the addressee-selecting rule. Moreover, the automatic linking can comprise determining when additional links are identifiable and successively linking to a plurality of other sites until no additional links are identifiable.

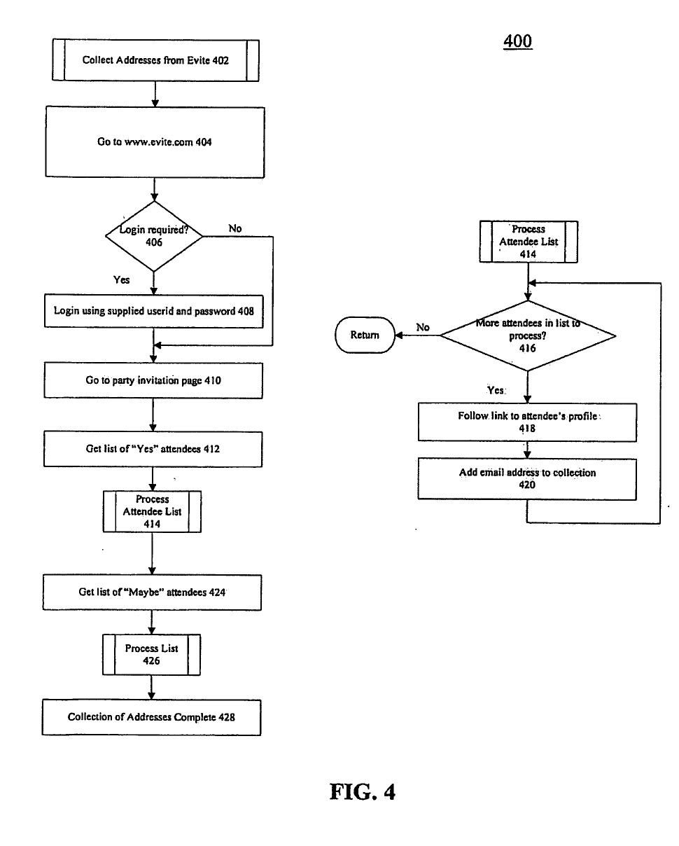

FIG. 4 is a flowchart illustrative of a method 400, according to another embodiment, for implementing an addressee-selecting rule for addressing invitations to a list of invitees. After start at step 402, addresses are collected from Evite, and thus at step 404, the method includes accessing Evite.Com™ over a data communications network to retrieve the addresses. A determination is made at step 406 as to whether a login is required, in which event, a userid and password are supplied at step 408. Otherwise, the method 400 proceeds directly to step 410, at which point a party invitation page is accessed. At step 412, a list of confirmed, or “yes,” attendees is obtained, and the list is processed at step 414.

As illustrated by the accompanying subroutine, the processing step 414 can further entail determining at step 416 whether additional attendees are to be processed. If so, a link is followed to the attendee's profile at step 418 and the attendee's address is added to the collection of identified attendees at step 420. When no additional attendees are to be processed, the subroutine returns to step 424.

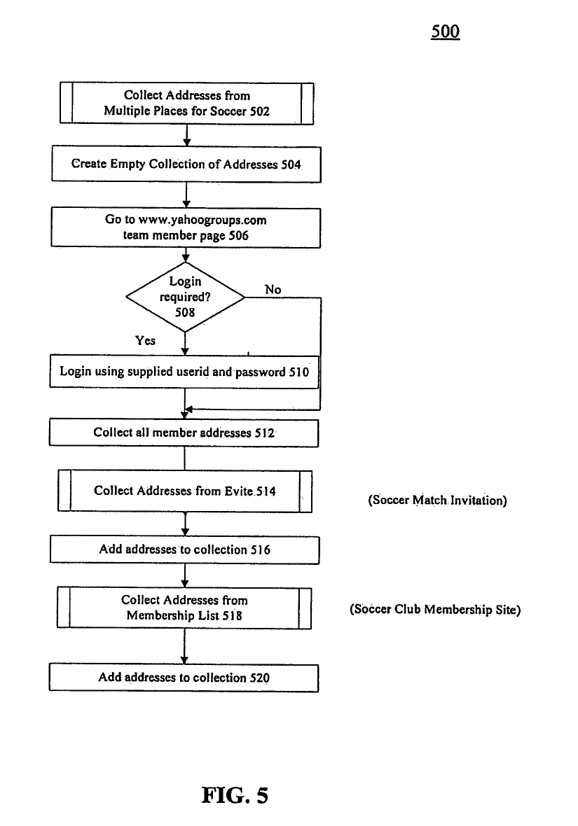

FIG. 5 is a flowchart illustrative of a method 500, according to yet another embodiment, for implementing an addressee-selecting rule for addressing invitations to a list of designated “soccer pals.” After start at step 502, addresses are collected from multiple sources. An initially-empty collection of addresses is generated at step 504, and a soccer team page, illustratively at www.yahoo.com is accessed at step 506. It is determined at step 508 whether a login is necessary. If so, a userid and password can be provided at step 510; otherwise the method 500 proceeds directly to step 512, at which point all member addresses are collected. At step 514, corresponding addresses are collected from Evite for the soccer match invitation. Addresses are added to the collection at step 516. Addresses from the soccer-club membership site are collected at step 518. The method 500 illustratively concludes at step 520 with all addresses added to the collection.

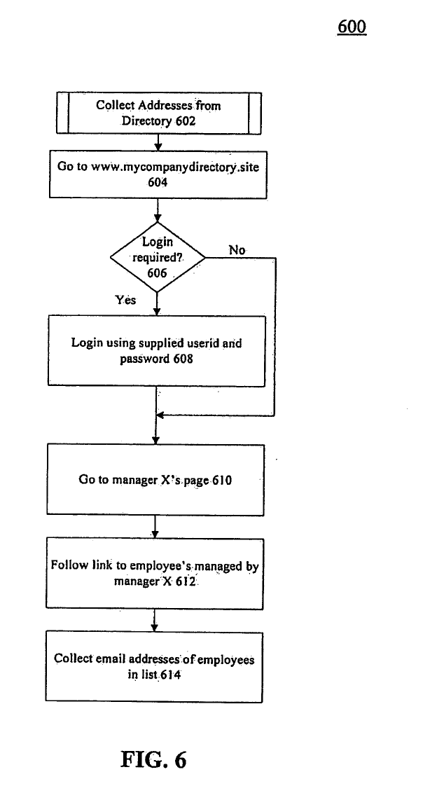

FIG. 6 is a flowchart illustrative of a method 600, according to still another embodiment, for implementing an addressee-selecting rule for addressing members of a particular department of an organization or entity. After start step 602, addresses are collected, from a department directory. Accordingly, at step 604 the company Website, illustratively www.mycompany.com, is accessed. It is determined at step 606 whether a login is required. If so, then at step 608 a userid and password can be provided. The method otherwise proceeds directly to step 610. At step 610, a manager's page is accessed and at step 612 links are followed to employees managed by the manager whose; page is accessed at the preceding step. The method concludes at step 614 with all employee email addresses being collected in a list according to the address-selecting rule.

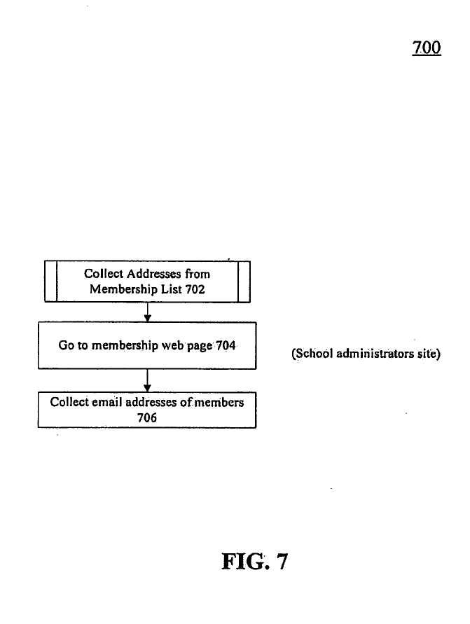

Similarly, FIG. 7 is a flowchart illustrative of a method 760, according to still another embodiment, for implementing an addressee-selecting rule for addressing members of a particular school administration. After start at step 702, addresses are collected from a membership list. The addresses are collected by accessing, at step 704, a representative school administrator site. The method concludes at step 706 with all the addresses being collected into a list according to the address-selecting rule.

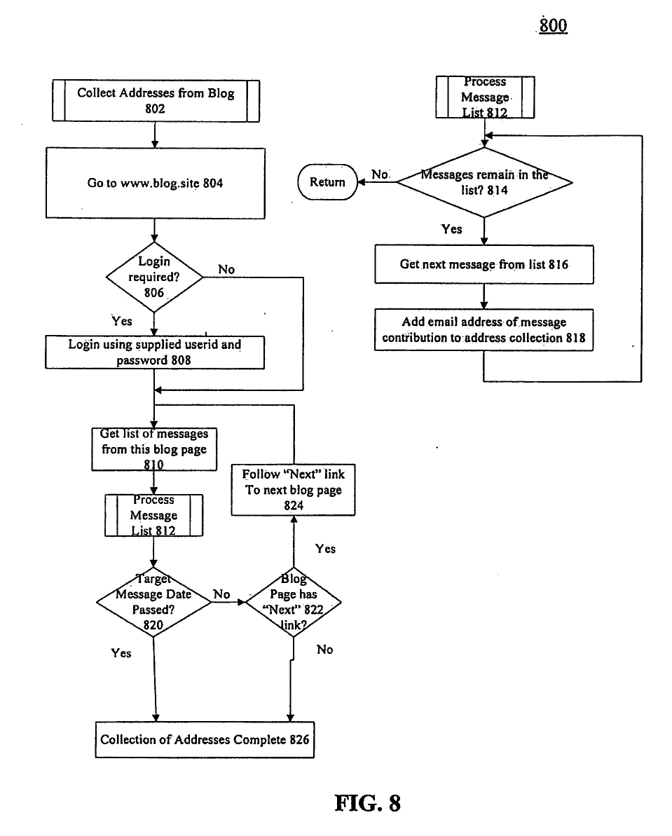

FIG. 8 is a flowchart illustrative of a method 800, according to yet another embodiment, for implementing an addressee-selecting rule corresponding to a list corresponding to the contributors to a particular blog. After start at step 802, the method 800 includes accessing the blog site (illustratively, www.blog.site) at step 804 to obtain addresses from the blog. It is determined at step 806 whether a login is required, and if so, a userid and password can be provided at step 808. Otherwise, the method 600 proceeds directly to step 810, at which point messages are obtained from the blog. At step 812 the subroutine for processing the list is accessed. The subroutine includes determining at decision block 814 whether there are additional messages to collect. If so, the method 800 continues at step 816 by retrieving the next message. At step 818, email addresses of identified contributors are added to the collection. The method 800 iteratively continues until no more messages remain, at which point the method 800 proceeds to step 820 where the determination is made as to whether a target message date has elapsed.

If the target message date has not elapsed, the method 800 proceeds to step 822, at which point a determination is made at decision block 824 as to whether the blog-page has a next link. If so, the next link is followed to the next blog page at step 826 to the blog is followed and the method 800 iteratively continues until the collection of addresses is complete at step 828.

According to yet another embodiment of the method 300, the selecting step can comprise selecting the one or more addressees from an electronic data file based upon a user-specified date and/or a user-specified time associated with the at least one addressee provided in the addressee-selecting rule. The method, according to another embodiment, can further include selecting, based upon the addressee-selecting rule, one of a plurality of electronically stored messages pre-specified by a user and inserting the message into a field of the e-mail prior to conveying the e-mail over a data communications network.

The invention, as also already noted, can be embedded in a computer program product, such as magnetic tape or optically-readable disk, in which is embedded computer-readable code. The code, defining a computer program, can be configured to implement the methods described herein when loaded in a computer system that is able to carry out these methods. Computer program in the present context means any expression, in any language, code, or notation, of a set of instructions intended to cause a system having an information processing capability to perform a particular function either directly or after either or both of the following: a) conversion to another language, code or notation; b) reproduction in a different material form.

The foregoing description of preferred embodiments of the invention have been, presented for the purposes of illustration. The description is riot intended to limit the invention to the precise forms disclosed. Indeed, modifications and variations will be readily apparent from the foregoing description. Accordingly, it is intended that the scope of the invention not be limited by the detailed description provided herein.

We claim:

1. A computer-implemented method for generating a customized dynamic distribution e-mail list, the method comprising:
in response to a user-executed command to send an e-mail, determining a predefined addressee-selecting rule;
based upon the addressee-selecting rule, selecting at least one addressee from an electronic data file; and
for each addressee selected, inserting a corresponding address into a predetermined field of an e-mail prior to conveying the e-mail over a data communications network.

2. The method of claim 1, wherein the selecting step comprises identifying the electronic data file from among a plurality of different data files based upon the addressee-selecting rule, and, in response thereto, accessing the electronic data file.

3. The method of claim 1, wherein the selecting step comprises accessing the electronic data file at a remotely-located site and automatically performing a log-in procedure to access the electronic data file based upon the addressee-selecting rule.

4. The method of claim 1, wherein the selecting step comprises accessing the electronic data file at a remotely-located site and automatically linking to another site based upon the addressee-selecting rule.

5. The method of claim 4, wherein automatically linking comprises determining when additional links are identifiable and successively linking to a plurality of other sites until no additional links are identifiable.

6. The method of claim 1, wherein the selecting step comprises selecting the at least one addressee from an electronic data file based upon at least one of a user-specified date and a user-specified time associated with the at least one addressee provided in the addressee-selecting rule.

7. The method of claim 1, further comprising selecting, based upon the addressee-selecting rule, one of a plurality of electronically stored messages pre-specified by a user and inserting the message into a field of the e-mail prior to conveying the e-mail over a data communications network.

8. A system for generating a customized dynamic distribution e-mail list, the system comprising:
at least one processor;
a network interface for communicatively linking the at least one processor to a data communications network; and
an addressee-selecting module that executes on the at least one-processor, the module configured to:
in response to a user-executed command to send an e-mail over the data communications network, determine a predefined addressee-selecting rule,
based upon the addressee-selecting rule, select at least one addressee from an electronic data file, and
for each addressee selected, inserting a corresponding address into a predetermined field of an e-mail prior to conveying the e-mail over a data communications network.

9. The system of claim 8, wherein the module is configured to identify the electronic data file from among a plurality of different data files based upon the addressee-selecting rule, and, in response thereto, access the electronic data file.

10. The system of claim 8, wherein the module is configured to access the electronic data file at a remotely-located site and to automatically perform a log-in procedure to access the electronic data file based upon the addressee-selecting rule.

11. The system of claim 8, wherein the module is configured to access the electronic data file at a remotely-located site and automatically link to another site based upon the addressee-selecting rule.

12. The system of claim 11, wherein the module is further configured to automatically determine when no additional links are identifiable and to successively link to a plurality of other sites until no additional links are identifiable.

13. The system of claim 8, wherein the module is configured to select the at least one addressee from an electronic data file based upon at least one of a user-specified date and a user-specified time associated with the at least one addressee provided in the addressee-selecting rule.

14. The system of claim 8, wherein the module is further configured to select, based upon the addressee-selecting rule, one of a plurality of electronically stored messages pre-specified by a user and to insert an address of a contributor of the selected message into a field of the e-mail prior to conveying the e-mail over a data communications network.

15. A computer-readable medium in which is embedded computer-readable code that when loaded on a computer causes the computer to:
determine a predefined addressee-selecting rule in response to a user-executed command to send an e-mail;
based upon the addressee-selecting rule, select at least one addressee from an electronic data file; and
for each addressee selected, insert a corresponding address into a predetermined field of an e-mail prior to conveying the e-mail over a data communications network.

16. The computer-readable medium of claim 15, wherein the computer-readable code causes the computer to select by identifying the electronic data file from among a plurality of different data files based upon the addressee-selecting rule, and, in response thereto, accessing the electronic data file.

17. The computer-readable medium of claim 15, wherein the computer-readable code causes the computer to select by accessing the electronic data file at a remotely-located site and automatically performing a log-in procedure to access the electronic data file based upon the addressee-selecting rule.

18. The computer-readable medium of claim 15, wherein the computer-readable code causes the computer to select by accessing the electronic data file at a remotely-located site and automatically linking to another site based upon the addressee-selecting rule.

19. The computer-readable medium of claim 18, wherein automatically linking comprises determining when additional links are identifiable and successively linking to a plurality of other sites until no additional links are identifiable.

20. The computer-readable medium of claim 15, wherein the computer-readable code causes the computer to select by selecting the at least one addressee from an electronic data file based upon at least one of a user-specified date and a user-specified time associated with the at least one addressee provided in the addressee-selecting rule.

21. The computer-readable medium of claim 15, further comprising computer-readable code that causes the computer to select, based upon the addressee-selecting rule, one of a plurality of electronically stored messages pre-specified by a user and to insert an address of a contributor of the selected message into a field of the e-mail prior to conveying the e-mail over a data communications network.
